(19) United States
(12) Patent Application Publication
(10) Pub. No.: US 2008/0239649 A1
(43) Pub. Date: Oct. 2, 2008

(54) Design structure for an interposer for expanded capability of a blade server chassis system

(76) Inventors: Thomas M. Bradicich, Apex, NC (US); Boyd K. Dimmock, Raleigh, NC (US); John D. Landers, Raleigh, NC (US); Edward S. Suffern, Chapel Hill, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/110,989

(22) Filed: Apr. 28, 2008

Related U.S. Application Data
(63) Continuation-in-part of application No. 11/693,282, filed on Mar. 29, 2007.

(51) Int. Cl. G06F 1/16

(52) U.S. Cl. 361/683

(57) ABSTRACT

A design structure embodied in a machine readable storage medium for designing, manufacturing, and/or testing a system chassis includes multiple chassis bays configured for receiving either of a single, conventional server blade or an adapter blade is provided. The adapter blade can selectively secure a plurality of compact blades, such as a blade PC. The adapter blade includes an interposer disposed for electronically communicating each compact blade with a server interface as a separate node upon securing a compact blade within any of the adapter bays. Each compact blade may be configured as a server, a “client blade” or “blade PC”, or a companion blade providing application-specific features. Therefore, the use of an adapter blade increases the flexibility of and capability of the processor system.

### CROSS-REFERENCE TO RELATED APPLICATION

This application is a continuation-in-part of co-pending U.S. patent application Ser. No. 11/693,282, filed Mar. 29, 2007, which is herein incorporated by reference.

### BACKGROUND OF THE INVENTION

1. Field of the Invention

The present invention is generally related design structures, and more specifically, design structures for interposers provided in chassis systems used with processor complexes.

2. Description of the Related Art

Multiple processor complexes, such as computer servers, are often consolidated into a centralized data center to facilitate their operation and maintenance. The servers in a data center are usually mounted in a rack or chassis to make efficient use of space and position the servers and other infrastructure within easy reach of an administrator. The IBM eServer BLADECENTER is one example of a compact server arrangement (IBM and BLADECENTER are registered trademarks of International Business Machines Corporation, Armonk, N.Y.). A rack can receive one or more chassis and stack them in an efficient manner. Each chassis includes a plurality of server bays, wherein each server bay is configured to receive a single server blade.

Recent innovations in rack-mounted desktop technology replace a local desktop personal computer (PC) with a rack-mountable “PC blade.” This moves the individual PC processors and related hardware, such as the CPU, motherboard, hard drive, and videocards, to a centralized location for easy access by the system administrator. Still, each workstation retains a familiar computing environment and has access to each user's PC blade via traditional user peripherals, such as a monitor, keyboard, and mouse.

A system chassis may be designed differently for each of a variety of applications depending upon the capabilities required by the application and the range of component performance that is available at the time. Accordingly, the significant advantages of using a system chassis have been implemented in specific applications by redesigning a processor complex and a system chassis that accommodates a plurality of these processor complexes. While the use of dedicated systems is beneficial, the processor complexes and system chassis adapted for a first application are not generally compatible with those adapted for a second unrelated application.

Therefore, the present inventors have identified a need for a system chassis that can accommodate more than one type of processor complex. It would be desirable if the system chassis would accommodate a mixed use of two or more different types of processor complexes. Furthermore, it would be desirable to operate each of the different processor complexes as a separate node. Finally, it would be even more desirable to adapt an existing system chassis to include the foregoing capabilities.

### SUMMARY OF THE INVENTION

The present invention provides an apparatus for use with a system chassis having a plurality of chassis bays and a server interface, wherein each chassis bay is configured for selectively securing a server blade, and wherein the server interface is disposed for electronic communication with a server blade upon securing the server blade within any of the plurality of chassis bays. The apparatus comprises an adapter blade configured to be selectively secured within any of the plurality of chassis bays and for electronic communication with the server interface upon securing the adapter blade within the chassis bay. The adapter blade includes a plurality of adapter bays configured for selectively securing a compact blade. The adapter blade also includes an interposer disposed for electronic communication with a compact blade upon securing a compact blade within any of the adapter bays. Electronic communication between the server interface and each compact blade is managed by the interposer, preferably establishing each compact blade as a distinct node.

The interposer provided as part of the adapter blade includes a controller in communication with the hardware interface, such as a midplane or backplane. The controller is preferably a baseboard management controller and is responsible for selectively assigning network addresses to the compact blades and recognizing individual vital product data from each compact blade in electronic communication with the interposer. Signals output by two or more compact blades to the server interface, such as USB or video signals, are handled by a multiplexer within the interposer. The multiplexer handles USB signals related to two or more compact blades.

Compact blades may include a blade PC, a companion card to a blade PC, or a blade server. Any combination of these compact blades may be configured within an adapter blade according to the present invention. In one configuration, the adapter blade receives a blade PC and a companion blade secured within an adjacent adapter bay of the same adapter blade and in electronic communication with the blade PC.

Other embodiments, aspects, and advantages of the invention will be apparent from the following description and the appended claims.

### BRIEF DESCRIPTION OF THE DRAWINGS

FIG. 1 is a partial front view of a data center housing a plurality of blade server system chassis.

FIG. 2 is a perspective view of a blade server chassis with a number of blade servers slidably inserted within bays formed in the chassis.

FIG. 3 is a perspective view of a conventional blade server removed from the bay of FIG. 2.

FIG. 4 is a perspective view of an adapter blade 35 aligned with a bay 16 in system chassis 12.

FIG. 5 is a perspective view of an adapter blade slidably insertable in a chassis bay and capable of receiving up to two compact blades.

FIG. 6 is a partial cutaway view of an adapter blade with compact blades partially inserted.

FIG. 7 is a partial schematic diagram of an exemplary networked processing system according to the invention.

FIG. 8 is a schematic diagram of a blade PC.

FIG. 9 is a perspective view of the adapter blade modified for Point of Sale (POS) applications and including a blade PC in combination with a retail blade.

FIG. 10 is a flow diagram of a design process used in mechanical and/or semiconductor design, manufacture, and/or test.

### DETAILED DESCRIPTION OF EMBODIMENTS

The present invention provides a system chassis having multiple bays. Each chassis bay is configured for receiving either a single, conventional server blade or an adapter blade which is itself configured for receiving a plurality of compact blades. Preferably, each of the plurality of compact blades may be configured as a different node of a processing system. Thus, a plurality of compact blades may now be installed in a chassis bay that is compatible with or designed for a single conventional server blade. A number of different useful and advantageous configurations of the system chassis may be achieved. For example, a compact blade may be configured as a server, allowing two or more servers to fit into a single chassis bay. Alternatively, a compact blade may be configured as a “client blade” or “blade PC,” effectively replacing a local desktop PC with a rack-mountable blade PC. Thus, two or more of the blade PCs, or other compact blade type, may now be installed in a single server bay. If one of the compact blades disposed in an adapter bay is configured as a blade PC, then another compact blade disposed in an adapter bay of the same adapter blade may be configured as a companion card to the blade PC. The companion card may be application-specific. For example, one of the compact blades may be configured for retail applications. Similarly, compact blades comprising a server and a client blade may be supported in a single bay.

One embodiment includes a system chassis having a plurality of chassis bays, each chassis bay being configured for receiving and securing a blade. Specifically, each bay can selectively secure either of a conventional server blade or an adapter blade. The adapter blade can selectively secure a plurality of compact blades.

In one embodiment, a design structure embodied in a machine readable storage medium for at least one of designing, manufacturing, and testing a design is provided. The design structure generally includes an apparatus, which includes a system chassis having a plurality of chassis bays and a server interface, wherein each chassis bay is configured for selectively securing a server blade, and wherein the server interface is disposed for electronic communication with a server blade upon securing the server blade within any of the plurality of chassis bays. The apparatus also generally includes an adapter blade configured to be selectively secured within any of the plurality of chassis bays and for electronic communication with the server interface upon securing the adapter blade within the chassis bay, wherein the adapter blade includes a plurality of adapter bays configured for selectively securing a compact blade and an interposer disposed for electronic communication with a compact blade upon securing a compact blade within any of the adapter bays, wherein the interposer manages electronic communication between the server interface and each compact blade as a distinct node.

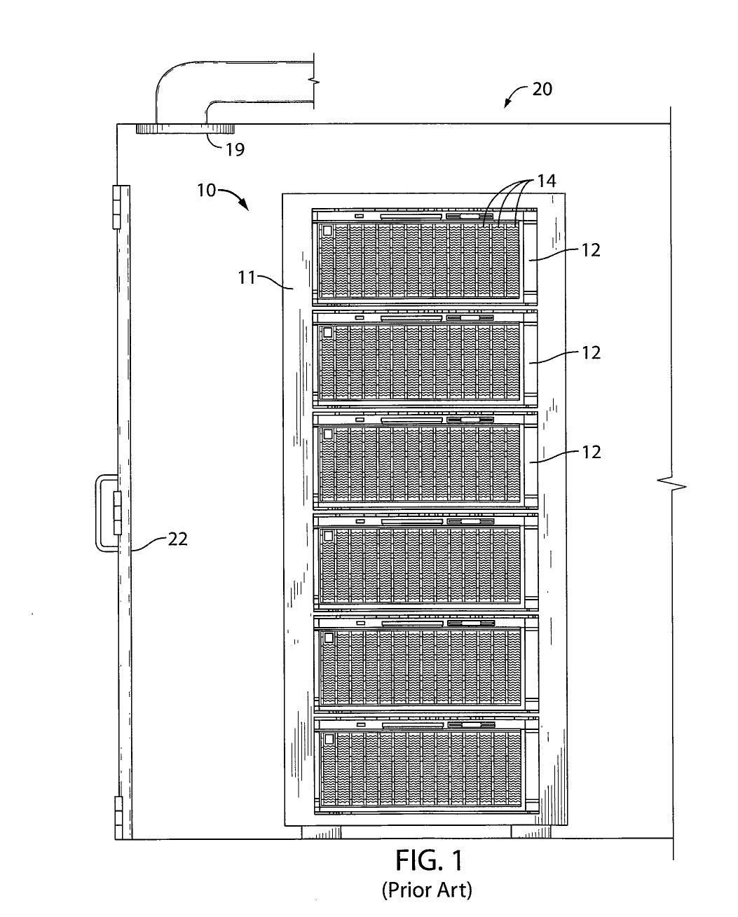

FIG. 1 is a front view of a data center 20 housing a rack system 10. The data center 20 includes a ventilation system 19 and other resources for controlling environmental parameters, such as temperature and humidity, for proper functioning of the rack system 10. The data center 20 is accessible by a system administrator through an entryway 22. The rack system 10 includes a rack 11 supporting six enclosures 12. A plurality of server blades 14 are slidably, removably disposed within each system chassis 12. Additional rack systems supporting additional system chassis may also be located in the data center 20. The rack system 10 provides an organized, efficient, and high-density arrangement for the many server blades 14. The server blades 14 are typically coupled through one or more networks to collectively provide a robust processing system. The data center 20 may be maintained, for example, by an organization for the purpose handling the data used in its operations. The data center 20 may provide a wide variety of services and functionality to a community of users, such as to employees in an office building who are connected to the server blades 14 in the rack system 10 via a LAN and/or to users more remotely networked via the Internet.

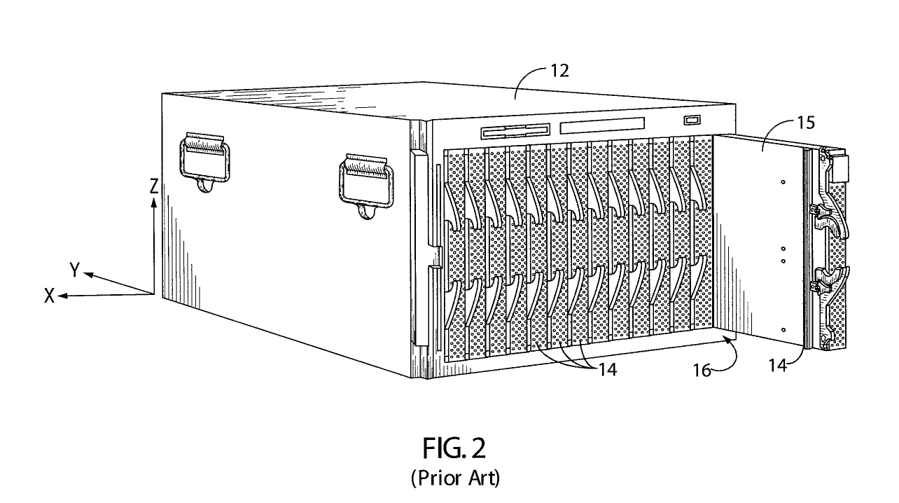

FIG. 2 is a perspective view of one of the system chassis 12 with server blades 14 slidably inserted. The server blades 14 are selectively secured in the system chassis 12 and are typically networked, although the topology may vary greatly as known in the art. One server blade 14 is shown only partially received in a bay 16. The server blade 14 includes an individual server blade enclosure 15 that houses a processor complex, including one or more CPUs, memory modules, PCI cards, fans, and hard drives. With reference to translational coordinates (x,y,z) in FIG. 2, the bay 16 substantially constrains the server blade 14, in terms of lateral (x) translation and vertical (z) translation, but is moveable by the user in a y direction, into and out of the bay 16. The bay 16 also constrains the server blade 14 rotationally, fixing its orientation in a substantially parallel relationship with adjacent server blades 14. Thus, the system chassis 12 constrains the server blades 14 at a fixed spacing and with face-to-face alignment. Depending on how tightly the server blade 14 fits in the bay 16, there may be a slight degree of lateral, vertical, or rotational “play” between the server blade 14 and the bay 16, without appreciably affecting the generally fixed spacing and parallel alignment of the server blades 14.

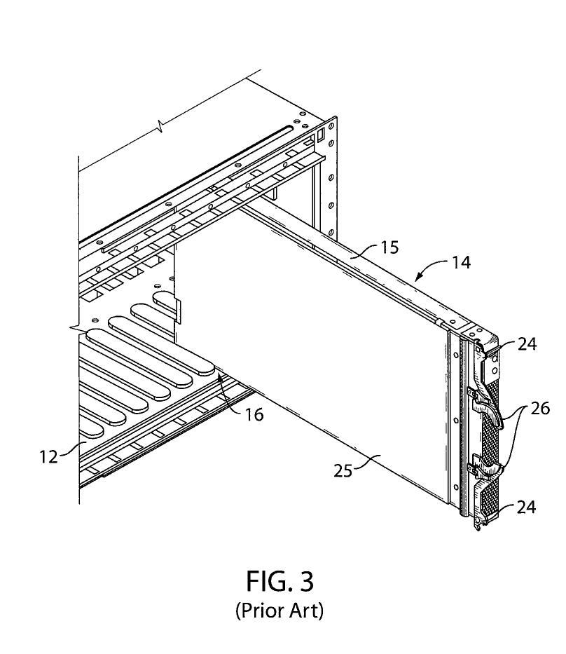

FIG. 3 is a perspective view of the conventional server blade 14 removed from the bay 16 of FIG. 2. The server blade 14 may be secured within the bay 16 using a latch 24 known in the art. The latch 24 includes a release lever 26 on a longitudinal side 25 of the server blade enclosure 15. When disposed in the bay 16, the server blade 14 is connected in electronic communication with a server interface (not shown). This connection is typically made via connectors formed on the end of the blade 14 that leads into the bay. The server interface allows the server blade 14 to interface with a processing system or network as a node, typically in conjunction with the support of a server operating system and other network hardware and software. In networking, a node may be generally described as a network device having its own processing location. Every node has a unique network address, such as a Data Link Control (DLC) address or Media Access Control (MAC) address. A node in the context of this embodiment is typically a server blade, compact blade or other hardware device having a processor complex, such as a client blade or client blade companion card, although other network devices such as a printer may also be configured as a node.

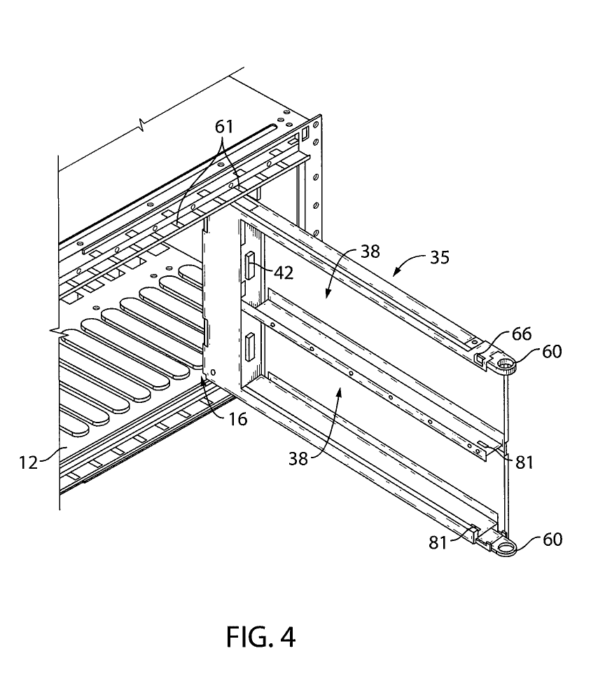

FIG. 4 is a perspective view of an adapter blade 35 aligned with a bay 16 in system chassis 12. The adapter blade 35 is configured to slide into the bay 16 and be selectively secured within the bay 16 in generally the same manner as the server blade 14 in FIG. 3. While the exact latching mechanisms may differ, the adapter blade 35 has compatible overall dimensions to those of a server blade in order to fit within the bay 16 and compatible electronic connectors, typically on the lead end of the adapter blade, in order to connect with a device, such as a midplane, in a similar manner as the server blade 14 in FIG. 3.

A latch 60 is provided at the top and bottom of the exposed end of the adapter blade 35 for selectively securing the adapter blade 35 within the enclosure 12 when fully seated in the bay 16. The latch 60 is secured when the projecting member 66 extends through the slot 61 formed in the system chassis 12. Though compact blades may be slidably inserted into the adapter bays 38 while the adapter blade 35 is outside of the bay 16, the adapter blade 35 in this embodiment is designed to be inserted into the bay 16 “empty” (i.e. without compact blades), prior to inserting the compact blades 32, 34 into the adapter blade 35. The latch 60 is preferably designed to prevent inadvertent removal of the adapter blade 35 while compact blades are installed. Accordingly, this embodiment requires the adapter blade 35 to first be inserted and latched into the bay 16 before inserting compact blades into the adapter blade 35. The adapter blade latch 60 is discussed further below.

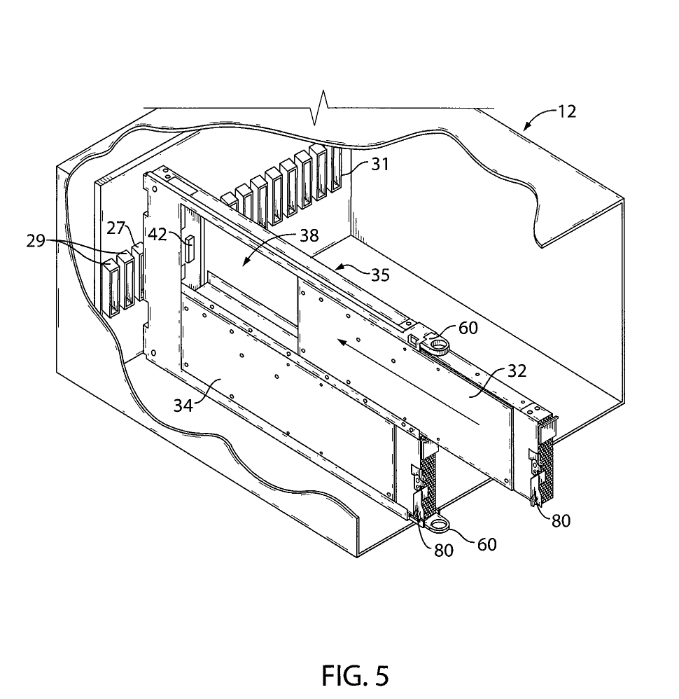

FIG. 5 is a perspective view of an adapter blade 35 and two compact blades 32, 34. The adapter blade 35 has been inserted and latched into a bay of the system chassis 12 wherein a connector on the leading end of the adapter blade 35 is in electronic communication with a backplane 31 via a connector 29. The adapter blade 35 may slidably receive the two compact blades 32, 34. The compact blades 32, 34 are separate hardware devices each having a processor complex, which may include one or more CPUs, memory modules, PCI cards, fans, and hard drives. The compact blades 32, 34 may be configured as servers, though their compact size relative to a conventional server blade correspondingly limits their complexity. Thus, the compact blades 32, 34 may be suited for configuring as a single-user PC, which typically requires less processing power and complexity than a conventional server. When configured as a single-user PC, a compact blade may be referred to as “client blade” or “blade PC.”

The compact blades 32, 34 may be independently positioned in or removed from the adapter bays 38 (See also FIG. 4). In FIG. 5, the compact blade 32 is shown partially inserted into the top bay 38 of the adapter blade 35, and the other compact blade 34 is shown fully inserted into the adapter blade 35. The adapter blade 35 preferably has a form factor similar to the server blade 14 of FIG. 3, so that the adapter blade is constrained similarly to a conventional server blade when disposed within the chassis bay 16. Thus, the adapter blade 35 may optionally be constructed from and/or use some of the same parts as a conventional server blade enclosure. The chassis bay 16, therefore, substantially constrains the adapter blade in terms of lateral (x) translation and vertical (z) translation, but the adapter blade is moveable by the user in a y direction, into and out of the bay 16. The bay 16 also constrains the adapter blade rotationally, fixing its orientation in a substantially parallel relationship with other server blades or adapter blades in adjacent bays. The system chassis 12 thereby constrains the adapter blade 35 and the included compact blades 32, 34 at a fixed spacing and with face-to-face alignment with any adjacent server blades or adapter blades. There may be a slight degree of lateral, vertical, or rotational “play” between the adapter blade and the bay 16 without appreciably affecting the generally fixed spacing and parallel alignment.

In another embodiment (not shown), the adapter blade 35 may be omitted, and the housing of the compact blades 32, 34 may be mechanically configured to be positioned in the chassis bay 16 without the adapter blade 35. The compact blades 32, 34 may sized to be constrained when disposed in the chassis bay 16.

A blade release mechanism 80 is provided on each compact blade 32, 34 for selectively securing each of the compact blades 32, 34 within the adapter blade 35 when fully seated within the adapter blade bays 38. The blade release mechanism 80 operates similarly to the conventional release mechanism 24 used for selectively securing the conventional server blade 14 within the bay 16. However, instead of latching directly to the system chassis 12, the compact blades 32, 34 latch to the adapter blade. For example, the latch 80 may selectively extend into a slot 81 formed in the adapter blade bay 38.

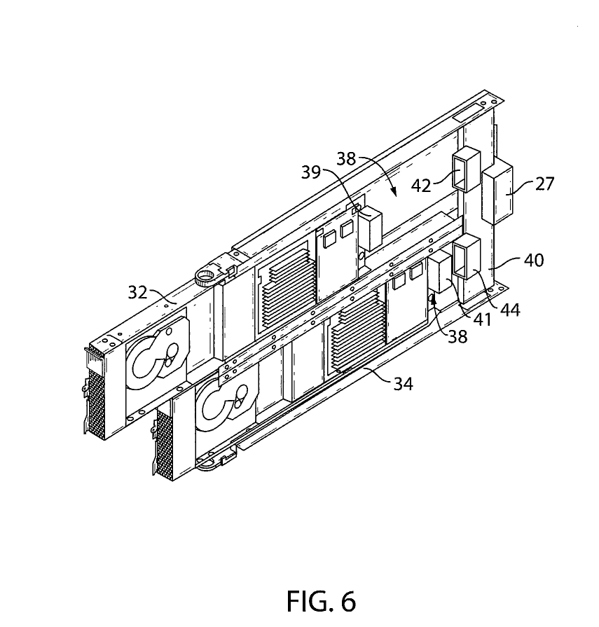

FIG. 6 is a partial cutaway view of the compact blades 32, 34 partially inserted into the adapter blade 35. Portions of the adapter blade housing and the compact blade enclosure have been removed to reveal an interposer 40 in the adapter blade and some of the electronic components of the compact blade modules 32, 34. The interposer 40 is a device that electronically couples each of the compact blades 32, 34 with the conventional server interface, such as the backplane 31 of FIG. 5. The interposer 40 connects to the conventional server interface or backplane connector 29 using one or more connectors 27 that optionally provide structural support to or constrain the interposer. In one aspect of the invention, the interposer 40 functions as a multi-device adapter, allowing each of the compact blades 32, 34 to be connected as separate nodes to the conventional server interface. Thus, two client blades (or some other combination of compact blades, such as a client blade and a companion card to the compact blade for retail environments) may now be connected to a processing system as separate nodes even though they are located within a common chassis bay 16, which previously accommodated only a single server blade connected as a single node.

The interposer 40 includes a first compact blade interface 42 for connecting the first compact blade 32 and a second compact blade interface 44 for connecting the second compact blade 34. The hardware interfaces 42, 44 may comprise one or more rigid connectors, but may also include cables or other types of connections. The interposer 40 may be positioned on the adapter blade 35 such that the action of moving the adapter blade 35 into the bay 16 connects the interposer 40 with the conventional server interface. For example, as the adapter blade 35 is inserted into the bay 16 to a fully seated position, connector 27 on the interposer 40 is coupled with connectors 29 on a midplane or backplane 31 (See also FIG. 5). The first and second compact blade interfaces of connectors 42, 44 are positioned in alignment with adapter bays 38 so that respective mating connectors 39, 41 on the leading end of the compact blades 32, 34 can be connected. The action of sliding the first compact blade 32 into the upper adapter bay 38 connects the connector 39 of first compact blade 32 with the first hardware interface 42, and the action of sliding the second compact blade 34 into the lower adapter bay 38 connects the connector 41 of the second compact blade 34 with the second hardware interface 44.

Though embodiments of the invention have been described having two compact blades disposed in a single bay, the invention does not limit a processing system to having only two compact blades per bay. In other embodiments, three or more compact blades may be disposed in a single bay and connected to a processing system as separate nodes. Also, the invention does not limit a bay and the associated multi-blade chassis to having a “1U” type of form factor. For example, a multi-blade chassis having bays with a “2U” form factor may be configured to receive more than two compact blades.

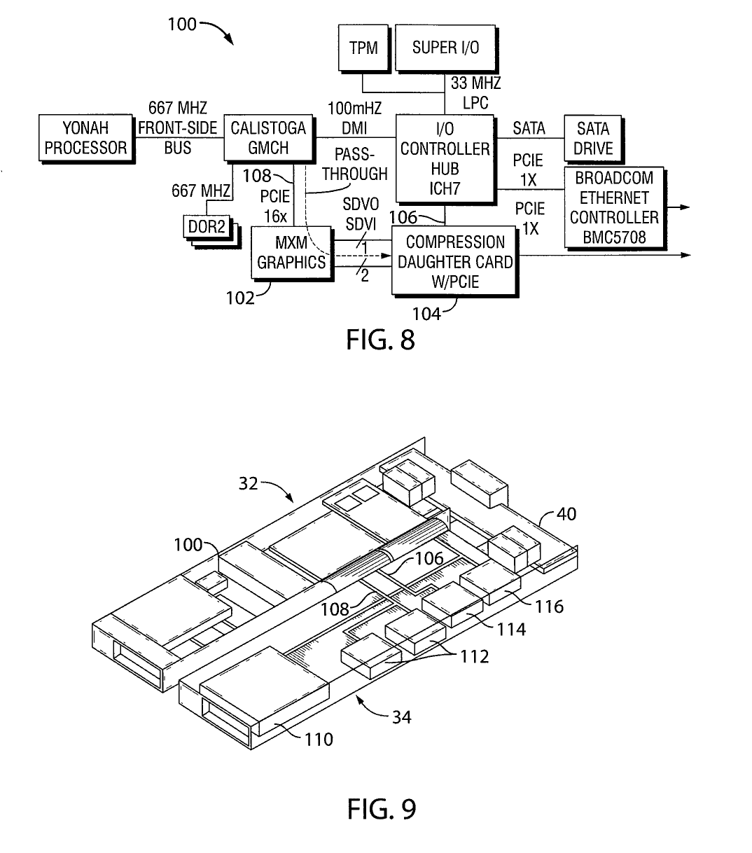

Still referring to FIG. 6, each compact blade 32, 34 includes a memory module 52. The memory modules 52 may each include any of a variety of memory storage mechanisms known in the art. For example, the memory modules 52 may include a hard disk commonly known as a hard disk drive (HDD) or hard drive (HD). Generally, a hard drive is a non-volatile storage device which stored digitally encoded data on rapidly rotating platters with magnetic surfaces for storage and retrieval of the digitally encoded data. Alternatively, the memory modules 52 may include flash memory, which is another form of non-volatile computer memory that can be electrically erased and reprogrammed. Each compact blade 32, 34 also includes a central processing unit (“CPU”) module 54 known in the art. The CPU module 54 may include a CPU and a heat sink. Typically, a CPU is a component in a digital computer that interprets computer program instructions and processes data. CPUs provide a fundamental digital computer trait of programmability. Other components of the compact blades are discussed below in connection with the schematic diagram of FIG. 8.

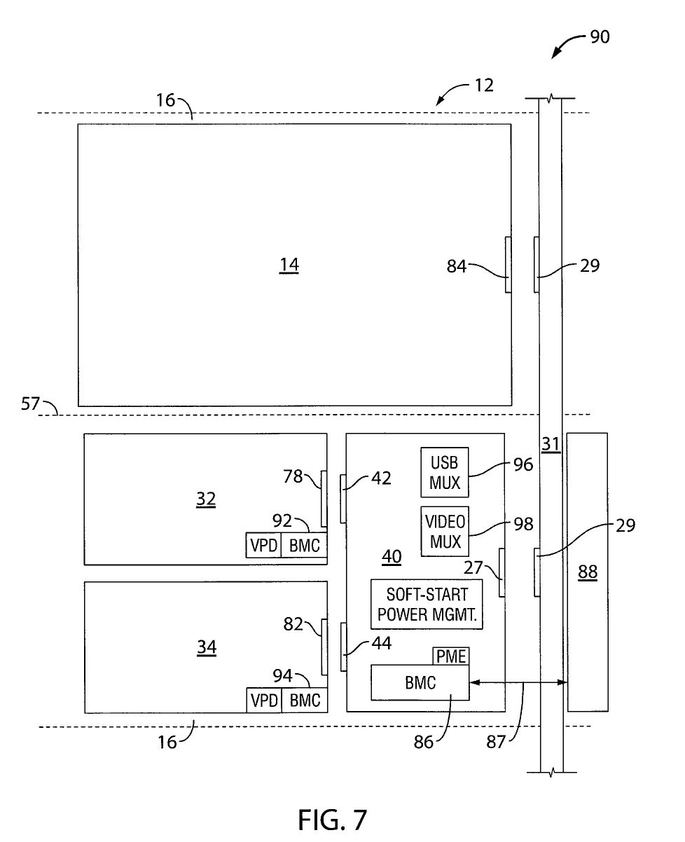

FIG. 7 is a partial schematic diagram of an exemplary networked processing system 90 according to the invention. The compact blades 32, 34 are disposed together in a first bay 16 of a system chassis 12 along with the interposer 40 for electronically interconnecting the compact blades 32, 34 to the rest of processing system 90 as different network nodes. Although the compact blades 32, 34 in this example include processors, other hardware devices could be implemented. The server blade 14 is disposed in a neighboring chassis bay 16, delineated from the adjacent chassis bay 16 by line 57, although a physical wall is not necessary to separate one bay from another. Each chassis bay 16 may have similar dimensions for accommodating either an individual server 14 or an adapter blade (not shown here) including the two compact blades 32, 34 together with the interposer 40. However, the processing system 90 is not drawn to scale, and the interposer 40 is not intended to convey its physical proportions relative to the compact blades 32, 34. The interposer 40 may be embodied in the form of a relatively narrow computer card.

Each chassis bay 16 includes, or is in alignment with, an associated hardware interface 29. The hardware interfaces 29 typically include one or more connectors and/or cables for electronically coupling hardware devices disposed in the respective bays 16 to the processing system 60. For example, the server blade 14 is connected to a hardware interface 29 disposed in the chassis bay 16, and the interposer 40 is connected to an identical hardware interface 29 disposed in the adjacent bay 16. In this embodiment, the hardware interfaces 29 are connectors disposed on a midplane or backplane 31. Midplanes and backplanes are circuit boards (usually, printed circuit boards) that include several connectors wired in parallel so that each pin of each connector is linked to the same relative pin of all the other connectors. Whereas a backplane generally resides at the back of a chassis, a midplane is located between the front and back of a system chassis. Midplanes are popular in networking where one type of device may be connected to one side of the midplane and another type of device may be connected to the other side of the midplane. Backplanes and midplanes are normally used in preference to cables because of their greater reliability.

The conventional server 14 includes a mating connector 84 for connecting with a hardware interface or connector 29 disposed in alignment at the end of the chassis bay 16. The interposer 40 includes a mating connector 27 for connecting with a hardware interface or connector 29 disposed in alignment at the end of the adjacent chassis bay 16. The interposer 40, itself, also includes a hardware interface or connector 42 disposed in alignment for connecting with connector 78 of the compact blade 32 and a hardware interface or connector 44 disposed in alignment for connecting with connector 82 of the compact blade 34. When so connected, the conventional server 14, compact blade 32, and compact blade 34 are preferably each connected within the processing system 90 as different nodes.

The connector 29 in each bay 16 may be substantially identical. Therefore, the processing system 90 can be alternatively configured by exchanging the position of the conventional server 14 with the position of the adapter blade, which includes the compact blades 32, 34 and the interposer 40. Alternatively, it should be recognized that the two bays 16 shown could similarly each secure and operate a server blade 14 or each secure and operate an adapter blade along with its components. Accordingly, the user if free to reconfigure the system chassis with server blades and adapter blades as necessary or desired.

The interposer 40 includes a baseboard management controller (“interposer BMC”) 86. The first and second compact blades 32, 34 each include a compact blade BMC 92, 94. A BMC is a specialized microcontroller that is typically embedded on a motherboard. In the context of a server or other computer system, the BMC manages the interface between system management software and platform hardware. Different types of sensors built into the computer system report to the BMC on parameters such as temperature, cooling fan speeds, power mode, and operating system (OS) status. The BMC monitors the sensors and can control operation in response. For example, a service processor may use a server BMC to monitor real-time power consumption by a server. Using this feedback, the service processor can selectively “throttle” the processors and/or memory on the server to maintain power consumption below a set point or “power ceiling” set by an administrator and monitored by a chassis management module 88.

In this embodiment, the interposer BMC 86 is preferably an “H8S-2166” type BMC. The interposer BMC 86 provides the “relay” function that intercepts commands of the management module 88 and makes the two compact blades 32, 34 “look” like a single entity. Basically, the interposer BMC 86 communicates to the management module 88 in the BladeCenter chassis. The management module queries the type of blade occupying the bay 16 and coupled to the connector 29 (for example, an adapter blade may have either two compact blades with identical function, such as two Client Blades, or two compact blades with one single function, such as a POS device). The interposer BMC 86 distinguishes between the functions of attached hardware or blade and communicates this information to the management entity 88. The management entity then treats the blade as two separate blades or a single blade, depending upon the blade configuration that has been identified. If the interposer BMC identifies the blade as a single blade or node, then the interposer BMC reports a single instance of the blade to the management module 88 and hence to the user. For example, a power on command from the management module 88 turns on the entire blade. Also, Vital Product Data from the single blade is reported to the management module as a single instance. However, in the case of two identical compact blades within the adapter blade, the interposer BMC is able to control power to each compact blade separately based on commands from the management module. Similarly, Vital Product Data is reported to the management entity 88 for each of the individual compact blades. Communication between the interposer BMC and the management module 88 may be provided by, for example, an RS-485 interface. An RS-485 interface (sometimes referred to as an EIA-485 interface) is an OSI Model physical layer electrical specification known in the art. The control of power to the individual compact blades may be governed by the interposer 40. Move this sentence before the RS-485 interface.

The interposer 40 further includes a plurality of multiplexers and/or demultiplexers (deMUX) for multiplexing signals to and from multiple entities, such as a compact blade processors, keyboard, video, mouse, and Ethernet interfaces. Generally, a multiplexer (abbreviated “MUX”) is a device that receives multiple signals and outputs a combined signal on a single channel, whereas a deMUX is a device that takes a combined signal and separates it out into its component signals. In this embodiment, the interposer 40 includes a USB MUX 96 and a Video MUX 98. Thus, for example, the interposer 40 may transmit signals from both compact blades 32, 34 and output the signals to the management module 88 via the device interface 29. In this manner, the signals from or to either compact blade 32, 34 may be handled.

Commands to the individual compact blades 32, 34 are read by the interposer BMC 86 and expanded to address both compact blades 32, 34 in the single bay 16. Signals containing information such as vital product data, temperature reporting, error reporting, and power control is exchanged with the respective compact blade BMC 92, 94.

The interposer 40 is configured to assign, configure, and enable the Serial over LAN functionality on each individual compact blade 32, 34 within the single bay 16. The Ethernet Internet Protocol (IP) address assignments may also occur on the interposer 40. Typically, the management module 88 assigns an “even-numbered” IP address to the interposer 40. The interposer BMC 86 then assigns the even-numbered IP address to one of the two compact blades 32, 34, and the odd-numbered IP address to the other of the two compact blades 32, 34. This IP assignment may be transparent to the management module 88.

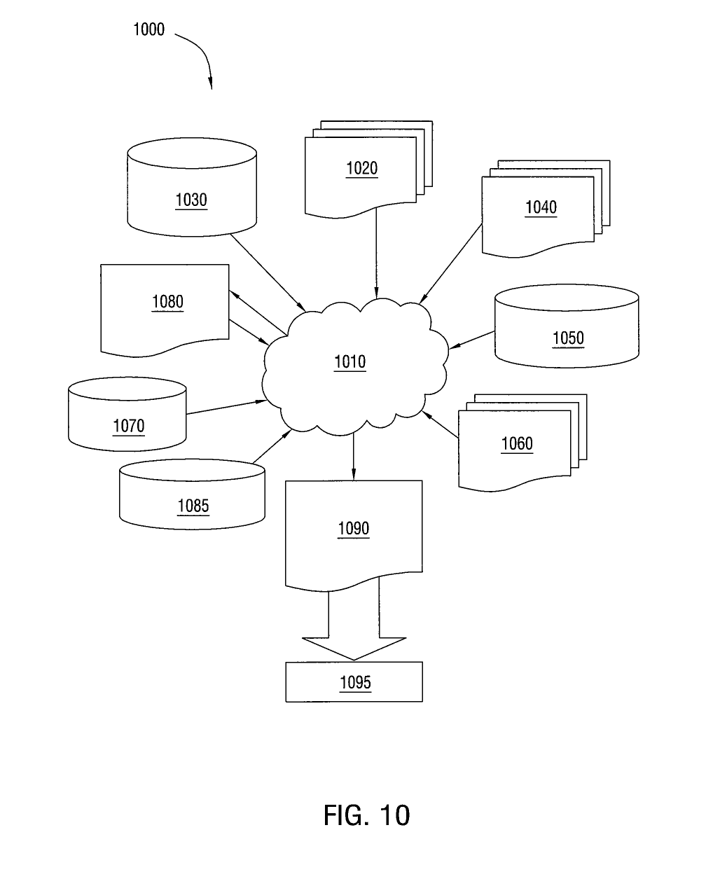

When an individual server blade 14 is disposed in the bay 16, the Vital Product Data of the server blade is communicated directly to the management module 88. However, when an adapter blade is received within the bay 16, then the interposer BMC 86 is able to distinguish which of the adapter bays 38 have received a compact blade and identify their function. For example, the interposer BMC can identify whether the two compact blades 32, 34 are both client blades, or if the first compact blade 32 is a client blade and the second compact blade 34 is an application-specific blade such as for use in retail environments. In particular, the interposer BMC 86 is able to read the vital product data for both compact blades 32, 34. Based on this vital product data, the interposer BMC 86 is able to determine the functionality of every component in the bay 16, e.g., whether the hardware in the bay 16 includes two client blades, or the combination of one client blade and one Retail blade. The interposer BMC 86 may then configure the keyboard, video, mouse, and Serial over LAN functions accordingly. A single BIOS load may be used to detect the different configurations. This BIOS load operates in conjunction with the interposer BMC. The interposer BMC detects each of the entities attached to the entire adapter blade. For example, this may include a single compact blade or a two connected compact blades as shown in FIG. 10. Based on this information, the BIOS initializes the functions and reports the device listing to the operating system. The operating system can then properly load specific device drivers to tailor the functions of the listed devices to the specific user requirements.

According to the present invention, a processing system may be customized for a particular environment or application. For example, one compact blade may be configured as a blade PC and the other compact blade may be configured as a companion card to the blade PC, as described in relation to FIGS. 8 and 9.

FIG. 8 is a schematic diagram of a blade PC 100. In one scenario, one of the compact blades is customized for use in retail point-of-sale (POS) applications. In this example, the compact blade PC 100 is configured as a controller/server in the blade PC environment. The graphics card 102 and user interface option cards 104 may be removed to expose a PCI Express (PCIe) bus 106 and an Intel chipset video subsystem bus 108. Next, the compact blade buses 106, 108 are exposed to the adjacent adapter bay or slot. Connections may then be added to extend the different buses to the adjacent adapter bay or slot. The POS operating system can then be loaded on the blade PC to re-configure it for POS server operations. This operating system is specific to the retail environment and makes use of the functions made available by the adjacent compact blade.

FIG. 9 is a perspective view of the compact blade 32 modified for POS applications as blade PC 100 and interconnected with a companion blade 34. The companion blade 34 is connected with the PCI Express bus 106 and the video subsystem bus 108. The SATA hard drive 110 and the other connectors shown allow the compact blades 32, 34 to operate as a POS server blade. For example, the additional video capabilities may be utilized in a video surveillance system. Using the same base planar design, the MxM graphics adapter 102 and the compression daughter card 104 are removed. These are removed for cost reasons so that the user can configure the adjacent compact blade to provide a different function, in this case POS. The adjacent compact blade is installed. This compact blade contains a second SATA hard drive 110, an NVRAM card 112, a PCIe extension 114 for video surveillance, and a KVM function 116. These additional functions tailor the blade to the POS environment. However, it should be recognized that the present invention is not limited by the functions and devices that can be provided by the compact blades, and that other functions and devices will become apparent to those having ordinary skill in the art upon learning of the present invention. In fact, the present invention is believed to facilitate the configuration and adaptation of other functions and devices, not specifically disclosed herein, to a system chassis environment. These further configurations are deemed to be within the scope of the present invention.

In one embodiment, FIG. 10 shows a block diagram of an exemplary design flow 1000 used for example, in mechanical design, manufacturing, and/or test. Design flow 1000 may vary depending on the type of mechanical device or structure being designed. For example, a design flow 1000 for building a custom device or structure may differ from a design flow 1000 for designing a standard component. Design structure 1020 is preferably an input to a design process 1010 and may come from a provider, a developer, or other design company or may be generated by the operator of the design flow, or from other sources. Design structure 1020 comprises the devices or structures described above and shown in FIGS. 4-9 in the form of schematics. Design structure 1020 may be contained on one or more machine readable medium. For example, design structure 1020 may be a text file or a graphical representation of a device or structure as described above and shown in FIGS. 4-9. Design process 1010 (e.g., a computer-aided design (CAD) process) preferably translates the devices and structures described above and shown in FIGS. 4-9 into different data formats and/or representations 1080, where the different data formats and/or representations 1080 include, for example, geometries (wireframe, surface and solid) and other attributes such as metadata, assembly structure and feature data, which describe the mechanical device or structure. The different data formats and/or representations may be subsequently recorded on at least one of machine readable medium. For example, the medium may be a storage medium such as a CD, a compact flash, other flash memory, or a hard-disk drive. The medium may also be a packet of data to be sent via the Internet, or other networking suitable means.

Design process 1010 may include using a variety of inputs; for example, inputs from library elements 1030 which may house a set of commonly used elements, and devices, including models and symbolic representations, for a given manufacturing technology, design specifications 1040, characterization data 1050, verification data 1060, design rules 1070, and test data files 1085 (which may include test patterns and other testing information). Design process 1010 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1010 without deviating from the scope and spirit of the invention. The design structure of the invention is not limited to any specific design flow.

Design process 1010 preferably translates a design or structure as described above and shown in FIGS. 4-9, along with any additional mechanical design or data (if applicable), into a second design structure 1090. Design structure 1090 resides on a storage medium in a data format used for the exchange of data of mechanical devices and structures (e.g. information stored in a IGES, DXF, Parasolid XT, JT, DRG, or any other suitable format for storing such mechanical design structures). Design structure 1090 may comprise information such as, for example, test data files, design content files, manufacturing data, layout parameters, shapes, data for routing through the manufacturing line, and any other data required by a manufacturer to produce a device or structure as described above and shown in FIGS. 4-9. Design structure 1090 may then proceed to a stage 1095 where, for example, design structure 1090: is released to manufacturing, is sent back to the customer, etc.

In another embodiment, FIG. 10 shows a block diagram of an exemplary design flow 1000 used for example, in semiconductor design, manufacturing, and/or test. Design flow 1000 may vary depending on the type of IC being designed. For example, a design flow 1000 for building an application specific IC (ASIC) may differ from a design flow 1000 for designing a standard component. Design structure 1020 is preferably an input to a design process 1010 and may come from an IP provider, a core developer, or other design company or may be generated by the operator of the design flow, or from other sources. Design structure 1020 comprises the circuits described above and shown in FIGS. 7-9 in the form of schematics or HDL, a hardware-description language (e.g., Verilog, VHDL, C, etc.). Design structure 1020 may be contained on one or more machine readable medium. For example, design structure 1020 may be a text file or a graphical representation of a circuit as described above and shown in FIGS. 7-9. Design process 1010 preferably synthesizes (or translates) the circuit described above and shown in FIGS. 7-9 into a netlist 1080, where netlist 1080 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 1080 is resynthesized one or more times depending on design specifications and parameters for the circuit.

Design process 1010 may include using a variety of inputs; for example, inputs from library elements 1030 which may house a set of commonly used elements, circuits, and devices, including models, layouts, and symbolic representations, for a given manufacturing technology (e.g., different technology nodes, 32 nm, 45 nm, 90 nm, etc.), design specifications 1040, characterization data 1050, verification data 1060, design rules 1070, and test data files 1085 (which may include test patterns and other testing information). Design process 1010 may further include, for example, standard circuit design processes such as timing analysis, verification, design rule checking, place and route operations, etc. One of ordinary skill in the art of integrated circuit design can appreciate the extent of possible electronic design automation tools and applications used in design process 1010 without deviating from the scope and spirit of the invention. The design structure of the invention is not limited to any specific design flow.

Design process 1010 preferably translates a circuit as described above and shown in FIGS. 7-9, along with any additional integrated circuit design or data (if applicable), into a second design structure 1090. Design structure 1090 resides on a storage medium in a data format used for the exchange of layout data of integrated circuits (e.g. information stored in a GDSII (GDS2), GL1, OASIS, or any other suitable format for storing such design structures). Design structure 1090 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIGS. 7-9. Design structure 1090 may then proceed to a stage 1095 where, for example, design structure 1090: proceeds to tape-out, is released to manufacturing, is released to a mask house, is sent to another design house, is sent back to the customer, etc.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A design structure embodied in a machine readable storage medium for at least one of designing, manufacturing, and testing a design, the design structure comprising:
an apparatus, comprising:
a system chassis having a plurality of chassis bays and a server interface,
wherein each chassis bay is configured for selectively securing a server blade, and wherein the server interface is disposed for electronic communication with a server blade upon securing the server blade within any of the plurality of chassis bays; and
an adapter blade configured to be selectively secured within any of the plurality of chassis bays and for electronic communication with the server interface upon securing the adapter blade within the chassis bay, wherein the adapter blade includes a plurality of adapter bays configured for selectively securing a compact blade and an interposer disposed for electronic communication with a compact blade upon securing a compact blade within any of the adapter bays, wherein the interposer manages electronic communication between the server interface and each compact blade as a distinct node.

2. The design structure of claim 1, wherein the server interface is selected from a midplane or a backplane.

3. The design structure of claim 1, wherein the compact blade is a blade PC, a companion card to a blade PC, or a blade server.

4. The design structure of claim 1, wherein the interposer includes a controller in communication with the hardware interface for selectively assigning network addresses to the compact blades.

5. The design structure of claim 4, wherein the controller is a baseboard management controller.

6. The design structure of claim 5, wherein the baseboard management controller recognizes individual vital product data from each compact blade in electronic communication with the interposer.

7. The design structure of claim 1, wherein the interposer further includes a multiplexer for multiplexing signals output by the compact blades to the server interface.

8. The design structure of claim 7, wherein the multiplexer handles USB signals related to two or more compact blades.

9. The design structure of claim 7, wherein the multiplexer handles Video signals related to two or more compact blades.

10. The design structure of claim 1, wherein the interposer further comprises a single BIOS in communication with the server interface.

11. The design structure of claim 1, further comprising a compact blade secured within one of the adapter bays.

12. The design structure of claim 11, wherein the compact blade is a blade PC.

13. The design structure of claim 12, further comprising a companion blade secured with an adjacent adapter bay of the same adapter blade and in electronic communication with the blade PC.

14. The design structure of claim 1 1, further comprising a second compact blade secured with an adjacent adapter bay of the same adapter blade.

15. The design structure of claim 14, wherein both compact blades are blade PCs.

16. The design structure of claim 12, wherein the blade PC has individual power control.

17. The design structure of claim 1, wherein the design structure comprises a data format, which describes the apparatus.

18. The design structure of claim 17, wherein the data format is selected for the exchange of data of mechanical devices and structures.

19. The design structure of claim 1, wherein the design structure comprises a netlist, which describes the system.

20. The design structure of claim 1, wherein the design structure resides on the machine readable storage medium as a data format used for the exchange of layout data of integrated circuits.
